(19) United States
(12) Patent Application Publication
(10) Pub. No.: US 2026/0070074 A1
(43) Pub. Date: Mar. 12, 2026

(54) SPRAY NOZZLE ASSEMBLY WITH STABILIZATION VANE

(71) Applicant: Spraying Systems Co., Wheaton, IL (US)

(72) Inventors: Geoff Tanner, Glendale Heights, IL (US); Maeve Shannon, Glendale Heights, IL (US); Kyle Smolinski, Glendale Heights, IL (US)

(21) Appl. No.: 19/325,202

(22) Filed: Sep. 10, 2025

Related U.S. Application Data
(60) Provisional application No. 63/693,456, filed on Sep. 11, 2024.

(51) Int. Cl. B05B 1/34; B05B 3/06

(52) U.S. Cl. CPC B05B 1/3402; B05B 3/06

(57) ABSTRACT

A spray nozzle assembly includes a nozzle body having an internal fluid passageway. A stabilization vane is arranged in the internal fluid passageway. The stabilization vane has a cross-sectional shape in a plane perpendicular to a longitudinal axis of the stabilization vane. The stabilization vane is formed from a single, continuous piece of material that is insertable in the internal fluid passageway. The cross-sectional shape of the stabilization vane has a center section defining a center passage through the stabilization vane that is arranged in a center of the internal fluid passage. The center section being flanked by a first side section and a second side section. Each of the first and second side sections being open to the center passage at a respective inner portion.

### CROSS-REFERENCE TO RELATED APPLICATIONS

This patent application claims the benefit of U.S. Provisional Patent Application No. 63/693,456, filed on Sep. 11, 2024, which is incorporated by reference.

### BACKGROUND OF THE INVENTION

Spray nozzle assemblies are used to discharge fluids in a variety of different industrial applications. Some of these applications involve fluid supplies that are highly turbulent. Turbulence can be introduced into the fluid supply by sharp turns, size reductions and other obstructions in the lines that supply fluid to the spray nozzle. Higher turbulence leads to more breakup of the fluid stream to the spray nozzle which can reduce the performance of the spray nozzle such as by reducing the impact and throw distance of the fluid discharged by the spray nozzle. These nozzle efficiency losses are exacerbated in applications involving high fluid flow rates.

In many situations involving turbulent flow, measures need to be taken to straighten the flow out before it is discharged from the spray nozzle. Stabilization vanes are one such measure. Stabilization vanes are structures that are inserted into the body of a spray nozzle to direct and guide fluid flow as it passes through the nozzle body and before it reaches the discharge orifice of the spray nozzle. In general, stabilization vanes divide the flow into smaller discrete flow paths that help focus the flow and thereby reduce turbulence.

There are number of drawbacks with existing stabilization vane designs. Stabilization vanes that perform best in high flow rate applications because they offer large, unobstructed fluid passages utilizing complicated geometries requiring welded joints that make the vanes expensive to manufacture. Such vanes are relatively rigid and thus difficult, time consuming and labor intensive to install in a spray nozzle body. Lower cost stabilization vanes are produced using metal stamping and thus are more affordable to manufacture than welded designs. However, the stamped stabilization vanes have more obstructions in the center region of the vane that hamper the performance of the vane, particularly in high fluid flow rate applications.

### OBJECTS OF THE INVENTION

In view of the foregoing, a general object of the present invention is to provide a spray nozzle assembly with a stabilization vane that is suitable for use in applications involving turbulent fluid supplies and high flow rates.

A related object of the present invention is to provide a stabilization vane the use of which leads to minimal efficiency losses in the performance of the spray nozzle assembly at high flow rates.

Another object of the present invention is to provide a stabilization vane that can be cost effectively manufactured.

A further object of the present invention is to provide a stabilization vane of the foregoing type that is quickly and easily insertable into a spray nozzle assembly.

Other objects and advantages of the invention will become apparent upon reading the following detailed description and upon reference to the drawings. The identified objects are not intended to limit the present invention.

### BRIEF DESCRIPTION OF THE SEVERAL VIEWS OF THE DRAWINGS

FIG. 1 is a perspective view of an exemplary embodiment of a spray nozzle assembly according to the present disclosure.

FIG. 2 is a side perspective view of the nozzle body of the spray nozzle assembly of FIG. 1.

FIG. 3 is an exploded, side perspective view of the nozzle body of FIG. 2 showing an embodiment of the stabilization vane.

FIG. 4 is a side sectional view of the nozzle body of FIG. 2.

FIG. 5 is an end view of the nozzle body of FIG. 2.

FIG. 6 is a side perspective view of the stabilization vane of FIG. 3.

FIG. 7 is an end view of the stabilization vane of FIG. 3.

### DETAILED DESCRIPTION OF THE INVENTION

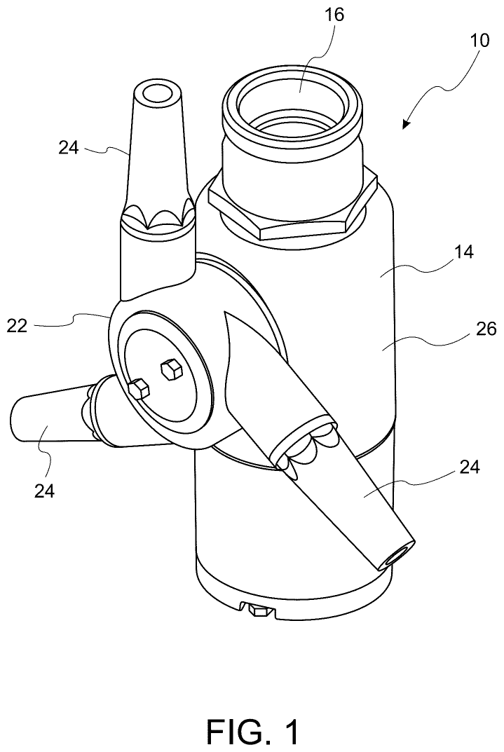

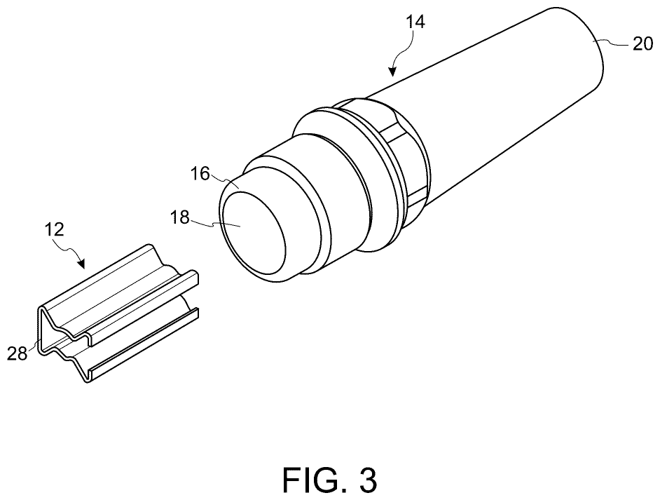

Referring to FIGS. 1-3 of the drawings, there is shown an exemplary embodiment of a spray nozzle assembly 10 according to the present invention. As discussed in greater detail below, the spray nozzle assembly 10 of the present disclosure includes a stabilization vane 12. In this case, the spray nozzle assembly 10 of FIG. 1 is specifically configured for use in a tank cleaning application. However, the spray nozzle assembly 10 and stabilization vane 12 of the present invention is not limited to tank cleaning applications. More specifically, the stabilization vane 12 of the present invention is not limited to use in spray nozzle assemblies that have particular configurations or that are intended for use in particular applications. To the contrary, the stabilization vane 12 and associated spray nozzle assembly 10 could be used in a variety of different applications to discharge a variety of different fluids. For example, the stabilization vane 12 and spray nozzle assembly 10 could be used in a variety of different industrial applications including, for example, tank cleaning and descaling applications. More generally, the stabilization vane 12 and spray nozzle assembly 10 could be useful in any application with a turbulent fluid supply, particularly those applications involving high flow rates and/or high pressure.

In the illustrated embodiment, the spray nozzle assembly 10 includes a nozzle body 14 that has a fluid inlet 16 on one end thereof which is configured for connection to a fluid supply, such as a fluid supply line. The nozzle body 14 further includes an internal fluid passageway 18 that extends in the downstream direction from the fluid inlet 16 and which directs fluid through the nozzle body 14 where it exits via a discharge opening 20. As used herein, in normal operation of the spray nozzle assembly 10, fluid flows from the upstream direction and towards the downstream direction, i.e., from upstream to downstream.

For directing fluid as it exits the nozzle body 14, as shown in FIG. 1, the illustrated spray nozzle assembly includes a hub 22 on which are supported, in this case, three discharge nozzles 24 that are in fluid communication with the discharge opening 20 in the nozzle body 14. In a known manner, the hub 22 is rotatably supported on a section 26 of the nozzle body 14 that also rotates relative to the remainder of the nozzle body 14 such that the discharge nozzles 24 are able to rotate through 360° in perpendicular horizontal and vertical planes. In this case, the rotation is fluidly driven such that movement of fluid through the spray nozzle assembly 10 drives rotation of the hub 22 and the rotating section 26 of the nozzle body 14. In other embodiments, the rotation may be driven by an electric motor. While the illustrated spray nozzle assembly 10 includes three discharge nozzles 24 on the rotary hub 22, other numbers of discharge nozzles could be provided.

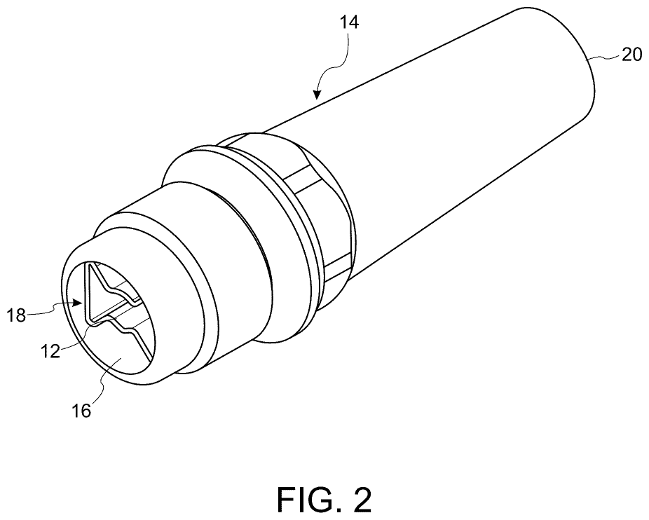

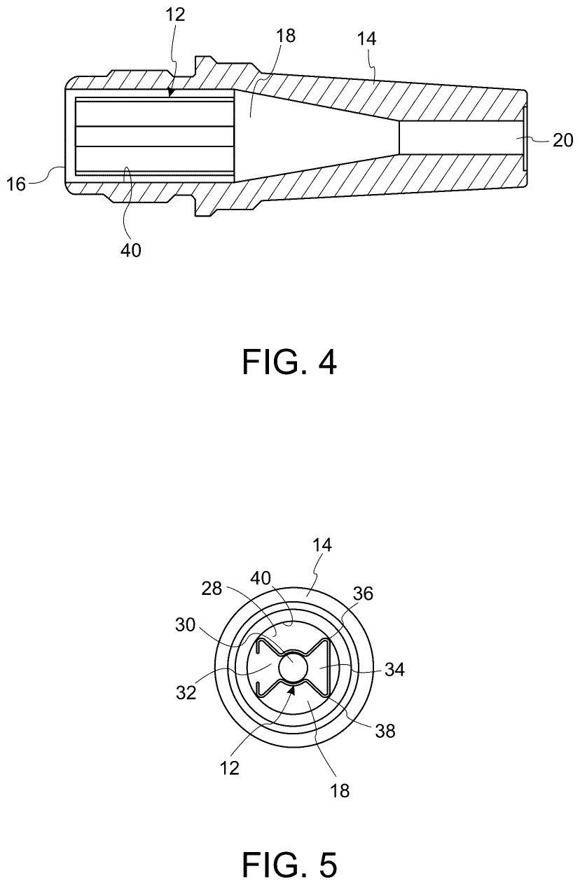

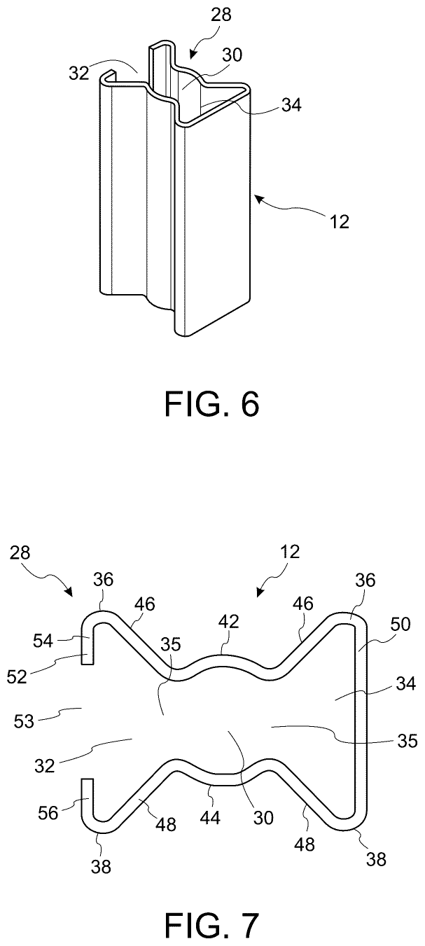

To guide and direct fluid as it enters the nozzle body 14 and thereby reduce fluid turbulence, the nozzle body 14 includes the stabilization vane 12. More specifically, the stabilization vane 12 is arranged in the internal fluid passageway 18 of the nozzle body 14 downstream of the fluid inlet 16 and upstream of the discharge opening 20 (see, e.g., FIGS. 2 and 4). The stabilization vane 12 has a longitudinal axis that extends a distance in the downstream direction of the nozzle body 14 (see FIG. 4) and has a cross-sectional shape in a plane perpendicular to the vane's longitudinal axis that is configured to concentrate and focus the fluid in the internal fluid passageway 18 of the nozzle body 12 producing a laminar flow through the center of the passageway and thereby increasing the efficiency of the spray emanating from, in this instance, the discharge nozzles 24. The longitudinal length of the stabilization vane 12 in the direction of fluid flow may vary depending on the size and configuration of the spray nozzle assembly 10 and nozzle body 14 with which it is being used. In general, the stabilization vane 12 should have a longitudinal length sufficient to produce the desired level of smoothing of the fluid flow. As described in greater detail below, the stabilization vane 12 comprises a separate element that is inserted in the internal fluid passageway 18. As noted above, while the present invention is described in the context of a rotating tank cleaning spray nozzle assembly, the stabilization vane 12 of the present disclosure is not limited to use in such a nozzle and can be used in the internal fluid passageway of any spray nozzle assembly.

The turbulence reducing effects produced by the stabilization vane 12 of the present disclosure are facilitated by the unique cross-sectional configuration of the stabilization vane 12. In particular, the stabilization vane comprises a body that has a bowtie-like or butterfly shape 28 when viewed in cross-section (i.e., transverse to the longitudinal axis of the stabilization vane 12) or on end as shown in FIGS. 5 and 7. With reference to FIG. 7, this bowtie/butterfly shape 28 enables the stabilization vane 12 to define a plurality of fluid passages, including a large center section 30 passage in the location at which fluid flow through the internal passageway 18 of the nozzle body 14 is at its highest velocity. This large center section 30 minimizes friction losses caused by the stabilization vane 12 which is particularly advantageous at high flow rates. This center section 30 is flanked by two generally triangular shaped side or wing sections 32, 34 each of which is open to the center passage at their inner corner portion 35 closest to the center section 30. These first and second triangular side sections 32, 34 help guide and focus the fluid flow into the center section 30 thereby intensifying the impact of the highest velocity flow at the center of the internal passageway 18 of the nozzle body 14. The first and second triangular side sections 32, 34 possess relatively thin walls and have a minimal surface area. As a result, the triangular side sections 32, 34 minimize obstructions at the outer edges of the internal fluid passageway 18 which stabilizes fluid flow while minimizing friction losses caused by drag particularly at high flow rates.

As shown in FIG. 5, the two outer corners 36, 38 of each of the first and second triangular side sections further define engagement points with the interior surface 40 of the internal fluid passageway 18 of the nozzle body 14. The engagement points defined by the outer corners 36, 38 help properly orient the stabilization vane 12 in the internal fluid passageway 18 of the nozzle body 14 and thereby help ensure that the center section 30 of the stabilization vane 12 is arranged in the center of the internal fluid passageway 18. Overall, the bowtie or butterfly shape 28 of the stabilization vane 12 allows the vane to be manufactured in a single continuous piece using a simple inexpensive metal stamping procedure without the need for any expensive welding.

Referring to FIG. 7, the center section 30 of the bowtie or butterfly shape 28 of the stabilization vane 12 includes opposing first and second arc-shaped wall segments 42, 44 that are substantially centered on the center of the internal fluid passageway 18 when the stabilization vane 12 is installed in the nozzle body 14. Extending outward from the center section 30 (as used herein inward is the direction towards the longitudinal axis of the stabilization and outward is away from the longitudinal axis), each of the first and second triangular side sections 32, 34 includes respective first and second legs 46, 48 that are straight and extend at an angle outward from a respective one of the arc shaped segments 42, 44 to respectively the first and second outer corners 36, 38 (i.e., the engagement points) of the respective triangular side section 32, 34. The first and second outer corners 36, 38 of the second triangular side section 34 are joined by a radially outermost third leg 50 that is substantially straight and, in this case, solid.

The first triangular side section 32 also includes a third leg 52 between the first and second outer corners 36, 38. However, in this case the third leg 52 has a break or open section 53 therein generally in the middle of the leg. This open third leg 52 allows the stabilization vane 12 to be compressed like a spring in the direction transverse to the longitudinal extent of the vane to ease installation of the stabilization vane 12 in the nozzle body 14. In particular, with this configuration, the stabilization vane 12 can be squeezed down by pressing the two end sections 54, 56 of the open third leg 52 towards each other for assembly and then, once inserted in the nozzle body 14, the stabilization vane 12 is able to resiliently spring back open to hold itself in place. This compression of the stabilization vane 12 can be done using a simple tool such as pliers or can even be done using one's fingers. This makes the stabilization vane 12 extremely easy to assemble. Moreover, the assembly can be done very quickly, minimizing assembly labor costs.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. A spray nozzle assembly comprising:
a nozzle body including a fluid inlet and a discharge opening, the nozzle body including an internal fluid passageway that extends from the fluid inlet to the discharge opening, the internal fluid passage of the nozzle body defining a direction of fluid flow; and
a stabilization vane arranged in the internal fluid passageway, the stabilization vane having a cross-sectional shape in a plane perpendicular to a longitudinal axis of the stabilization vane, the longitudinal axis of the stabilization vane extending in the direction of flow defined by the internal fluid passage, the stabilization vane being formed from a single, continuous piece of material that is insertable in the internal fluid passageway;
wherein the cross-sectional shape of the stabilization vane has a butterfly configuration with a center section defining a center passage through the stabilization vane that is arranged in a center of the internal fluid passage, the center section being flanked by a first side section and a second side section with the first and second side sections being on opposite sides of the center section, each of the first and second side sections being open to the center passage at a respective inner portion.

2. The spray nozzle assembly of claim 1, wherein each of the first and second side sections has a triangular configuration with the inner portion of the respective side section that is open to the center passage being an inner corner portion nearest to the center section.

3. The spray nozzle assembly of claim 2, wherein each of the first and second side sections has first and second outer corners that define engagement points with an interior surface of the fluid passageway.

4. The spray nozzle assembly of claim 3, wherein the center section of the stabilization vane includes opposing first and second arc-shaped wall segments.

5. The spray nozzle assembly of claim 4, wherein each of the first and second arc-shaped wall segments is centered on a center of the internal fluid passageway.

6. The spray nozzle assembly of claim 5, wherein each of the first and second side sections includes a first leg and a second leg, the first leg extending from an end of the first arc-shaped wall segment to the first outer corner and the second leg extending from an end of the second arc-shaped wall segment to the second outer corner.

7. The spray nozzle assembly of claim 6, wherein the first side section includes a third leg between the first and second outer corners, the third leg having an open section therein that allows for compression of the stabilization vane in the plane perpendicular to the longitudinal axis of the stabilization vane.

8. The spray nozzle assembly of claim 7, wherein the second side section includes a third leg extending between the first and second outer corners.

9. A stabilization vane for insertion in a central passageway of a nozzle body, the stabilization vane comprising:
a body having a cross-sectional shape in a plane perpendicular to a longitudinal axis of the stabilization vane, the stabilization vane being formed from a single, continuous piece of material that is insertable in the internal fluid passageway;
wherein the cross-sectional shape of the stabilization vane body has a butterfly configuration with a center section defining a center passage through the stabilization vane, the center section being flanked by a first side section and a second side section with the first and second side sections being on opposite sides of the center section, each of the first and second side sections being open to the center passage at a respective inner portion.

10. The stabilization vane of claim 9, wherein each of the first and second side sections has a triangular configuration with the inner portion of the respective side section that is open to the center passage being an inner corner portion nearest to the center section.

11. The stabilization vane of claim 10, wherein each of the first and second side sections has first and second outer corners that define engagement points with an interior surface of the fluid passageway.

12. The stabilization vane of claim 11, wherein the center section of the stabilization vane includes opposing first and second arc-shaped wall segments.

13. The stabilization vane of claim 12, wherein each of the first and second arc-shaped wall segments is centered on a center of the internal fluid passageway.

14. The stabilization vane of claim 13, wherein each of the first and second side sections includes a first leg and a second leg, the first leg extending from an end of the first arc-shaped wall segment to the first outer corner and the second leg extending from an end of the second arc-shaped wall segment to the second outer corner.

15. The stabilization vane of claim 14, wherein the first side section includes a third leg between the first and second outer corners, the third leg having an open section therein that allows for compression of the stabilization vane in the plane perpendicular to the longitudinal axis of the stabilization vane.

16. The stabilization vane of claim 15, wherein the second side section includes a third leg extending between the first and second outer corners.
